(19) United States
(12) Patent Application Publication
(10) Pub. No.: US 2006/0237872 A1
(43) Pub. Date: Oct. 26, 2006

(54) Release agent for plastic materials

(75) Inventor: Guenther Ittmann, Gross-Umstadt (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: ROEHM GBMH & CO KG, Darmstadt (DE)

(21) Appl. No.: 10/566,000

(22) PCT Filed: Apr. 13, 2004
(86) PCT No.: PCT/EP04/03868

§ 371 Date: Jan. 27, 2006

(30) Foreign Application Priority Data
Jul. 31, 2003 (DE) 103 35 577.4

(51) Int. Cl. B29C 33/60

(52) U.S. Cl. 264/300

(57) ABSTRACT

The alkylamino salt of mono- or dialkyl-substituted phosphoric acid can be used as release agent in polymers.

### FIELD OF THE INVENTION

The invention relates to internal release agents for plastics. Internal release agents are substances or mixtures of substances which inhibit the adhesion of the finished, fully polymerized plastics moulding to the mould.

### PRIOR ART

It is known that plastics sheets can be produced via polymerization of suitable monomers and/or monomer mixtures, which may also be a prepolymerized syrup, in cells with walls composed of glass plates, e.g. float glass.

The glass plates usually form the floor and the ceiling of the cell, and the cells are sealed at the side by suitable means, such as flexible beads or tapes composed of material resistant to the monomer.

The products are marketed with the name Plexiglas® GS by Röhm GmbH & Co. KG.

A known problem with cast polymerization is glass breakage.

Glass breakage is the breakage of the glass plates during demoulding of the fully polymerized plastics mouldings. In the event of glass breakage, not only does the pane of float glass have to be replaced, the production plant has to be manually cleaned to remove the resultant glass splinters. Reject PMMA is moreover produced. Production stops. There are a number of known alternatives for preventing glass breakage.

DE 198 32 018 describes a process for the silanization of moulds which have an inner surface composed of glass. The silanization of the glass plates is achieved via polymerization of a polymerizable composition which comprises a silanizing agent. The resultant polymer sheet is recycled, and the silanized glass plates are used for the polymerization process.

U.S. Pat. No. 3,935,292, for example, describes the possibility of silicone-oil treatment of moulds which have an inner surface composed of glass. To this end, the glass surface is coated with silicone oil, and then heated to 150-350° C. Any excess of silicone oil is removed prior to use.

This process has a number of appendant disadvantages.

First, the adhesion between glass plate and the plastic cannot be varied. This leads to problems in the handling of the glass plates, and also to poor control in the demoulding of the plastics sheets, which tend to slide out of the mould of their own accord. The use of these silanized glass plates is therefore problematic for reasons of workplace safety. A fact which has to be taken into account here is that the use of a smaller amount of polysiloxane would not lead to a solution of these problems, because the polysiloxane layer has to be complete, i.e. coherent. Otherwise, the layer would be peeled away relatively rapidly. The process described serves in particular for the production of contact lenses. When such small mouldings are being produced, the above considerations are hardly significant. In contrast to this, plastics sheets with dimensions of about 2 m*3 m*1 cm have considerable weight, and the arguments set out above cannot therefore be ignored.

Another disadvantage which can arise through insufficient adhesion is that, depending on the polymerization process used, the PMMA sheets obtained do not have smooth surfaces. During polymerization in a water bath, the “flexible beads” are removed after a prepolymerization process, in order that shrinkage does not cause the plastic to peel away from the glass plates. If the adhesion of the plastic to the glass plates of the mould is insufficient, water can penetrate between glass plate and plastic, giving a non-smooth surface and thus leading to rejects. This is moreover a batch process, i.e. an additional plant or workstation has to be provided for the silanization of the glass plates. Other disadvantages arising here are found in the interruption of production needed to install the silanized glass plates.

In order to prevent this breakage of glass, an internal release agent is added to the monomer mixture to be polymerized, and this release agent is intended to prevent excessive adhesion of the plastics moulding to the glass.

The company Axel produces a release agent and markets it with the name Mold Wiz int AM 121, for use as an internal release agent in the cast process for the polymerization of PMMA.

The agent is composed of triethylamine and mono- and di(octyl/decyl/dodecyl) phosphate (content: about 12 mol %) and isopropyl ester of fatty acid (content: about 11 mol %) dissolved in benzyl alcohol (65 mol %).

Disadvantages of the Prior Art

A disadvantage of commercially available release agent is the high content of benzyl alcohol, which is expensive and susceptible to oxidation.

Object and Achievement of Object

An object was therefore to find an internal release agent which does not require the solubilizer benzyl alcohol with its disadvantages.

An advantage of internal release agents over the external release agents known in the prior art is that they can be added at very low concentrations to the monomer mixture to be polymerized.

It is possible to omit complicated operations, such as the application of the release agent to the glass plate.

In addition, the release agent required should be toxicologically non-hazardous. It should also be capable of effective metering.

Achievement of Object

It has been found that a compound of the general formula I
Rₙ¹PO₃^{Θ}(HN^{⊕}—R₃²)ₘ

where:
n=1 or 2
m=2 or 1 and n+m=3

Where if m=1 the anion has a single negative charge and if m=2 the anion has a double negative charge,

R¹=methyl, ethyl, propyl, isopropyl, butyl, isobutyl, pentyl, hexyl, heptyl, octyl, nonyl, decyl, undecyl, or dodecyl

R²=methyl, ethyl, propyl, isopropyl or butyl,

exhibits good release action when used in amounts of from 0.001 to 0.5% by weight in a polymerizable monomer mixture.

As polymerizable monomer mixture, use may be made of methyl methacrylate and monomers copolymerizable with MMA.

Polymerizable monomer mixtures are tert. compositions which comprise ethylenically unsaturated monomers and/or prepolymerized monomers (syrups). These compositions preferably comprise monomers or syrups which are suitable for producing what may be called organic glass or synthetic glass.

Among the abovementioned ethylenically unsaturated monomers which may be present in the polymerizable monomer mixtures are vinyl esters, esters of acrylic acid, e.g. methyl acrylate and ethyl acrylate, esters of methacrylic acid, e.g. methyl methacrylate, butyl methacrylate and ethylhexyl methacrylate, vinyl chloride, vinylidene chloride, vinyl acetate, styrene, substituted styrenes having an alkyl substituent in the side chain, e.g. α-methylstyrene and α-ethylstyrene, substituted styrenes having an alkyl substituent on the ring, e.g. vinyltoluene and p-methylstyrene, halogenated styrenes, e.g. monochlorostyrenes, dichlorostyrenes, tribromostyrenes and tetrabromostyrenes, vinyl ethers and isopropenyl ethers, maleic acid derivatives, e.g. maleic anhydride, methylmaleic anhydride, maleimide, methyl maleimide, and dienes, such as 1,3-butadiene and divinylbenzene, preference being given to acrylic esters, methacrylic esters, vinyl acetate, vinyl chloride, vinylidene chloride, styrene, α-methylstyrene, halogen-substituted styrenes, vinyl ethers, isopropenyl ethers and dienes, and very particular preference being given to methyl methacrylate.

Very particularly preferred embodiments of the inventive process feature the use, as polymerizable composition, of a (meth)acrylate-containing resin with the following composition +M1 +HZ,1/32 !,3 (meth)acrylate (A)? +TR,13 20-99.9%? ,21 by weight,? !comonomers (B)? 0-79.9%? by weight,? !polymers (C), soluble? 0-70.0%? by weight? !in (A) or in (B)? !and, based on 100? !parts of the above-? !mentioned compounds:? !initiators? 0.005-5? parts by weight? !and also other? 0-10? parts by weight.? !conventional? !processing aids+TZ,1/32 ? !!

(Meth)acrylate means acrylic and/methacrylic compounds, as mentioned above by way of example. Comonomers are compounds copolymerizable with (meth)acrylates. Among these are the abovementioned monomers other than (meth)acrylate. By way of example, polymers which may be present dissolved in the polymerizable composition are polymers or copolymers of the above-mentioned monomeric constituents. Initiators and processing aids are described below.

The abovementioned monomers may also be used as mixtures, and also in prepolymerized form, as what may be called syrups.

All of the abovementioned monomers are commercially available. However, they may also be prepared by any method known to the person skilled in the art.

The polymerizable compositions may comprise the conventional additives.

By way of example, mention may be made of the following additives: antistatic agents, antioxidants, further mould-release agents, flame retardants, lubricants, dyes, flow improvers, fillers, light stabilizers and organic phosphorus compounds, such as phosphites or phosphonates, pigments, weathering stabilizers and plasticizers.

The amount used of the additives is conventional, i.e. up to 80% by weight, preferably up to 30% by weight, based on the total weight. If the amount is greater than 80% by weight, based on the total weight, properties of the polymerizable composition, e.g. processability, may be impaired.

According to the invention, the polymerizable composition is poured into a mould whose inner surface is composed at least to some extent of inorganic glass.

Mould means any of the moulds which are usually used. This mould may have been assembled from various components, where one component of the mould has a glass surface. The expression “at least to some extent” means that the proportion of the glass surface, based on the entire inner surface of the mould, is at least 10%, preferably more than 30% and very particularly preferably more than 80%. If the proportion of the glass surface is smaller than 10%, the inventive advantage resulting from reduced glass breakage is negligible.

By way of example, one preferred mould encompasses two glass plates, a ceiling plate and a base plate, the sides of which are separated and sealed by suitable measures, e.g. tapes or flexible beads. By way of example, the glass plates may be held together by metal clamps and have by way of example an area of 2 m* 3 m and a thickness of from about 2 to 20 mm, preferably from 3 to 12 mm. There are also what may be called multiple cells, in particular twin cells, which have a layered structure, the central glass plates being in contact on both sides with the polymerizable composition.

Inorganic glass for the mould materials encompasses in particular cooled melts which, by way of example, may comprise silicon dioxide (SiO₂), calcium oxide (CaO), sodium oxide (Na₂O), sometimes with relatively large amounts of boron trioxide (B₂O₃), aluminium oxide (Al₂O₃), lead oxide (PbO), magnesium oxide (MgO), barium oxide (BaO), potassium oxide (K₂O) and other additives.

Once the mould has been filled, the polymerizable composition is polymerized to give a moulding. Polymerization here means any of the processes known to persons skilled in the art and taking place in bulk, for example bulk polymerization, which is described by way of example in Houben-Weyl, volume E20, Part 2 (1987), p. 1145 et seq.

The polymerization may take place by a free-radical or ionic route, free-radical polymerization being preferred. It may use heat, radiation, and initiators, preference being given to the use of initiators which form free radicals. The particular conditions of polymerization depend on the monomers selected and on the initiator system, and are well-known to persons skilled in the art.

Among the preferred initiators are the azo initiators well-known to persons skilled in the art, e.g. AIBN or 1,1-azobiscyclohexanecarbonitrile, and also peroxy compounds, e.g. methyl ethyl ketone peroxide, acetylacetone peroxide, ketone peroxide, methyl isobutyl ketone peroxide, cyclohexanone peroxide, dibenzoyl peroxide, tert-butyl peroxybenzoate, tert-butyl peroxy isopropyl carbonate, 2,5-bis(2-ethyl-hexanoylperoxy)-2,5-dimethylhexane, tert-butylperoxy 2-ethylhexanoate, tert-butylperoxy 3,5,5-trimethylhexanoate, 1,1-bis(tert-butylperoxy)cyclohexane, 1,1-bis(tert-butylperoxy) 3,3,5-trimethylcyclohexane, cumyl hydroperoxide, tert-butyl hydroperoxide, dicumyl peroxide, bis(4-tert-butylcyclohexyl) peroxydicarbonate, mixtures of two or more of the abovementioned compounds with one another, and also mixtures of the abovementioned compounds with compounds not mentioned which can likewise form free radicals.

Once the moulding has been obtained, it is demoulded, i.e. removed from the mould. This procedure is dependent on the mould used and is known per se to persons skilled in the art.

It has now further been found that the reaction product, by way of example, of a mixture of monononyl (30-35% by weight) and dinonyl (65-70% by weight) phosphate with triethylamine, used in the form of pure material, also has an outstanding release action. Furthermore, the inventive product is acid-resistant, and this property permits its use in formulations which comprise acidic components, e.g. methacrylic acid, acrylic acid or stearic acid.

Use of the Inventive Compound as Release Agent

The inventive compound is a suitable release agent during the cast polymerization of MMA. Its amounts used are from 0.001 to 7.5% by weight, based on the total weight of the mixture undergoing production, preferably in amounts from 0.005 to 5% by weight and very particularly preferably in amounts from 0.01 to 5% by weight.

1. Preparation of the Inventive Product

1600 g of the mixture of monononyl (30-35% by weight) and dinonyl (65-70% by weight) phosphate (Zelec® UN, producer: DU PONT) form an initial charge in a reaction flask, and 492.3 g of triethylamine is added dropwise, with stirring. A temperature of >50° C. is reached during this exothermic reaction. After the dropwise addition, stirring is continued for a further 30 min. This gives a clear reaction product with a slight yellow tint.

2. Preparation of a Methyl Methacrylate (MMA)-PMMA Syrup

MMA is treated with 0.07% by weight of bis(4-tert-butylcyclohexyl)peroxydicarbonate, and the material is dissolved, with stirring. 50% of the solution are heated to about 90° C., with stirring. The other 50% of the solution are fed into the heated solution in such a way as not to exceed a temperature of 93° C. The reaction is then allowed to continue for a further period of about 2-3 min, and then the MMA-PMMA syrup is rapidly cooled to room temperature. The polymer content of the syrup is about 20%, and has a molecular weight of about 170 000.

### EXAMPLES OF THE USE OF THE INVENTIVE PRODUCT AS MOULD-RELEASE AGENT

### Example 1

A cell is built using 2 silicate glass panes of dimensions 40×50 cm and a round PVC bead of thickness 3.6 mm, the cell being held together by metal clamps. The space within this cell is filled with the following polymerization mixture:
0.05% by weight of inventive compound of the formula I, where:
   n=2
   m=1
   R¹=methyl
   R²=ethyl
0.08% by weight of 2,2-azobis(isobutyronitrile)
99.87% by weight of MMA-PMMA syrup

The additives are dissolved in the MMA-PMMA syrup, with stirring. Once the cell has been sealed, the polymerization is carried out for 17 h at 45° C. in a water bath. The metal clamps and the round bead are then removed, and the polymerization reaction in the cells is heated over a period of 3 h at 115° in a heat-conditioning cabinet. After cooling to room temperature, the glass panes were removed and demoulding of the acrylic sheet from the glass panes was assessed.

### Example 2 (Comparative Example)

The procedure was as in Example 1, without addition of the inventive compound.

Results:

1. Assessment of Demouldability of the Acrylic Sheet from the Silicate Glass Panes of the Mould.

### Example 1

⅔ of the acrylic sheet peeled away from the glass of the mould during removal of the round bead. The remaining ⅓ of the acrylic sheet spontaneously peeled away from the silicate glass after removal from the heat-conditioning cabinet.

### Example 2: (Comparative Example)

After removal of the cell from the heat-conditioning cabinet, both silicate glass panes were demoulded from the acrylic sheet, whereupon a typical (cracking) noise was heard, indicating marked adhesion of the acrylic sheet to the silicate glass panes.

1. A method for inhibiting adhesion of a plastic to a mold, the method comprising:
providing a compound Rₙ¹PO₃^{Θ}(HN^{⊕}—R₃²)ₘ (I)
as a release agent during the cast polymerization of methyl methacrylate mixtures, wherein:
R¹=methyl, ethyl, propyl, isopropyl, butyl, isobutyl, pentyl, hexyl, heptyl, octyl, nonyl, decyl, undecyl, dodecyl
R²=methyl, ethyl, propyl, isopropyl, butyl;
n=1 or 2;
m=2 or 1 and n+m=3.

2. The method of claim 1, wherein the compound of the formula I is present in an amount of 0.01-5% by weight, based on the weight of the polymerizable monomers or monomer mixture composed of (meth)acrylates and other copolymerizable monomers, as the release agent.

3. The method of claim 1, wherein the release agent is useful for the production of plastics moldings composed of (meth)acrylates and Bother copolymerizable monomers.

4. A plastics molding composed of (meth)acrylates and other copolymerizable monomers, comprising:
a compound of formula I
Rₙ¹PO₃^{⊕}(HN^{⊕}—R₃²)ₘ (I)
as a release agent during the cast polymerization of methyl methacrylate mixtures, wherein:
R¹=methyl, ethyl, propyl, isopropyl, butyl, isobutyl, pentyl, hexyl, heptyl, octyl, nonyl, decyl, undecyl, dodecyl;
R²=methyl, ethyl, propyl, isopropyl, butyl;
n=1 or 2;
m=2 or 1; and
n+m=3.
